(19) United States
(12) Patent Application Publication
(10) Pub. No.: US 2008/0078657 A1
(43) Pub. Date: Apr. 3, 2008

(54) Oriented needled felt conveyor belt

(75) Inventors: John Hawkins, Loganville, GA (US); Mark McCurdy, Winder, GA (US)

Correspondence Address: DUANE MORRIS LLP, PO BOX 5203, PRINCETON, NJ, 08543-5203, US

(73) Assignee: J.H. Fenner & Co. Ltd

(21) Appl. No.: 11/542,481

(22) Filed: Oct. 3, 2006

(51) Int. Cl. B65G 15/30

(52) U.S. Cl. 198/846

(57) ABSTRACT

A conveyor belt construction is disclosed comprising at least two layers of carded nonwoven material that are needled together to form the carcass. A first layer of nonwoven material is carded so that a substantial portion of the staple fibers are oriented in a first direction. The second layer of nonwoven material is carded so that a substantial portion of the staple fibers are oriented in a second direction, which is substantially perpendicular to the first direction. The two layers of material are then layered on each other and needled together to form a dual layer belt carcass. The carcass is then impregnated with an elastomer such as polyvinyl chloride. The strength of the belt in the longitudinal and transverse directions may be adjusted by adjusting the weight ratio of the nonwoven layers. A method for manufacturing the multi-layer nonwoven belt is also disclosed.

### FIELD OF THE INVENTION

The invention generally relates to an improved low noise conveyor belt design, and more particularly to a design for a needled felt carcass conveyor belt having improved strength.

### BACKGROUND

Conveyor belts and conveyor systems are well known systems used for the transport of a variety of materials and products. Conveyor belts are designed and used in heavy materials transport, such as coal mining and cement manufacturing operations, and in medium and light weight applications such as light materials handling operations, package handling and transport, and the like. For certain lightweight applications, such as airport baggage handling, parcel/package handling and distribution center facilities, conveyor belts are required to operate below prescribed noise levels, to ensure a more comfortable and safe working environment.

To achieve such low noise, the belts often incorporate one or more layers of nonwoven material to reduce the sound generated by the contact between the belt and the conveyor machinery (e.g., the rollers and pulleys). Conventional lightweight belts, which often utilize a woven fabric to provide strength, are quite noisy due to the “washboard” interaction between the fabric weave and the conveyor rollers. Nonwoven materials have thus been used with some success to provide a smoother interaction between the belt and the conveyor rollers. Since nonwovens by definition don't have a fabric “weave” the interaction between the belt and the conveyor structure is smoother. Additionally, nonwoven materials provide some sound damping due to the substantial air volume contained between the fibers.

Current low noise belts often consist of layers of scrim or other reinforcing material integrated with layers of nonwoven material sandwiched between the reinforcing material layers or provided as a covering thereto. The scrim reinforcing layers are used to provide strength and thus typically are made from woven or knitted material having higher longitudinally-disposed (i.e., “weft”) yarns. High or moderate strength laterally-disposed (i.e., “warp”) yarns provide lateral belt strength and resistance to fastener pullout. As noted, the nonwoven materials provide the low-noise characteristics, and are not relied upon to provide strength to the belt.

It would be advantageous to reduce or the total number of different materials and layers required in a desired low-noise belt, since providing a belt with multiple different material layers increases material and manufacturing production costs. Specifically, it would be advantageous to eliminate the scrim layers so that the belt carcass is made from nonwoven material alone. One difficulty that, until now, has made such a design impractical is that such nonwoven belts may not have adequate strength to perform in a wide variety of applications. Nonwoven materials can be much weaker than woven or knitted scrim, which is why scrim layers traditionally are added to the belt carcass.

Thus, there is a need for an improved non-woven conveyor belt design for use in a wide variety of low-noise conveying applications. Such an improved belt should provide low stretch, excellent fastener holding strength, and high resistance to impact, cutting and edge wear as compared to current nonwoven belts.

### SUMMARY OF THE INVENTION

The disadvantages heretofore associated with the prior art are overcome by the inventive design for a conveyor belt having a multiply needled felt design. The inventive design provides advantages including cost-effectiveness, efficiency and the desired strength as compared to previous designs.

A conveyor belt structure is disclosed comprising a first layer of nonwoven material having a substantial portion of staple fibers oriented in a first direction and a second layer of nonwoven material having a substantial portion of staple fibers oriented in a second direction. The second layer of nonwoven material may be disposed over said first layer of nonwoven material, and an elastomer may be dispersed within at least a portion of the first and second layers of nonwoven material. The first layer of nonwoven material may be oriented with respect to the second layer of nonwoven material such that the first direction is non-parallel with the second direction.

A conveyor belt structure is disclosed comprising a first layer of nonwoven material having a substantial portion of staple fibers oriented in a first direction and a second layer of nonwoven material having a substantial portion of staple fibers oriented in a second direction. The second layer of nonwoven material may be disposed over the first layer of nonwoven material, and an elastomer material may be dispersed within at least a portion of the first and second layers of nonwoven material. The first layer of nonwoven material further may be oriented with respect to said second layer of nonwoven material such that the first direction is non-parallel with the second direction.

A method of making a belt structure is disclosed, comprising: providing a first nonwoven layer having a first staple fiber orientation; providing a second nonwoven layer have a second staple fiber orientation; disposing the first nonwoven layer on the second nonwoven layer and needling the layers together to form a unitary structure; and impregnating at least a portion of the unitary structure with an elastomeric compound.

A continuous process for making a multi-ply nonwoven conveyor belt structure is disclosed, comprising: providing a first roll of nonwoven material having a first staple fiber orientation; providing a second roll of nonwoven material have a second staple fiber orientation; dispensing the first and second rolls of nonwoven material in a machine direction; disposing the first nonwoven material on the second nonwoven material and needling the layers together to form a unitary structure; and impregnating at least a portion of the unitary structure with an elastomeric compound.

### BRIEF DESCRIPTION OF THE DRAWINGS

The details of the invention, both as to its structure and operation, may be obtained by a review of the accompanying drawings, in which like reference numerals refer to like parts, and in which:

FIG. 1. is an isometric cutaway view of a conveyor belt employing the inventive nonwoven carcass structure;

FIG. 2 is an isometric view of a first nonwoven material layer, in roll form, for use in the carcass of FIG. 1;

FIG. 3 is an isometric view of a second nonwoven material layer, in roll form, for use in the carcass of FIG. 2;

FIG. 4A is an isometric view of the first and second nonwoven material layers laid on one another; FIG. 4B is a detail view of first and second nonwoven layers of FIG. 4A each being made up of individual sublayers;

FIG. 5 is an isometric cutaway view of the carcass of FIG. 4 incorporating a pair of optional reinforcement layers;

FIG. 6A is an isometric view of a joint formed between opposing sections of conveyor belt, including the fasteners used to hold sections together during operation;

FIG. 6B is a cross-section view, taken along line 6B-6B of FIG. 6A, showing the engagement of the fasteners with the nonwoven layers;

FIG. 7 is a schematic view of a system for continuously manufacturing the conveyor belt of FIG. 1.

### DETAILED DESCRIPTION

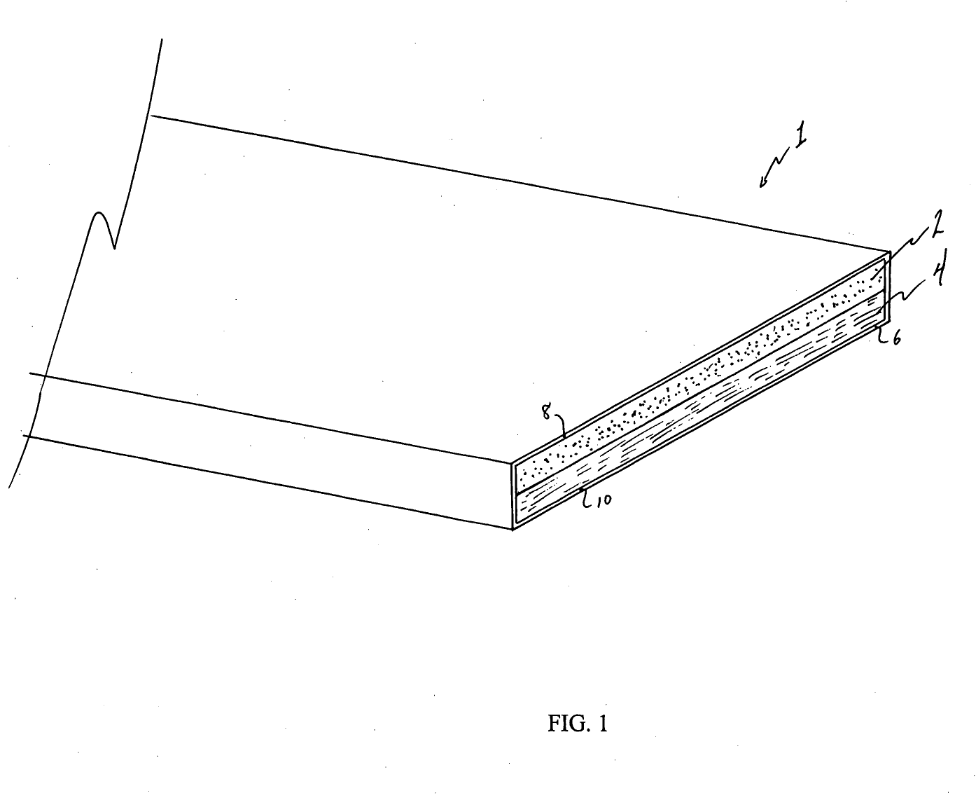

Referring to FIG. 1, a cross-section of multi-layer non-woven conveyor belt 1 is shown with first and second nonwoven layers 2, 4, and an elastomer component 6 that covers and at least partially impregnates the nonwoven layers 2, 4. The first and second nonwoven layers 2, 4 may be fixed together by needling to form a carcass 12, and the elastomer component may serve to bond the layers, as well as the individual fibers making up each layer, together. In some embodiments the elastomer component 6 may also form top and bottom cover layers 8, 10 of the conveyor belt 1. In one embodiment, the first and second nonwoven layers 2, 4, each may comprise staple polyester nonwoven felt material, while the elastomer component 6 may be polyvinyl chloride (PVC).

One or both of the first and second nonwoven layers 2, 4 may individually be subjected to a needling process to increase the strength and stability of the layers, prior to layers being fixed together to form the carcass 12. Moreover, the first and second nonwoven layers 2, 4 may together be subjected to a needling process to bind the layers together prior to application of the elastomer component 6. This needling process may fix the layers together in a desired orientation, as will be discussed in greater detail later. As will be appreciated, the specific techniques of needling nonwoven materials are well known and will not be discussed in detail herein.

The nonwoven layers 2, 4 may comprise any appropriate nonwoven material, which in one exemplary embodiment is a pressed felt material composed of multidirectional staple fibers. Left in an uncarded, unneedled state, these nonwoven layers 2, 4 may have less than desirable strength in either the lateral or longitudinal direction, and thus would be unsuitable for use as structural layers in a conveyor belt. Thus, in order to enhance the strength of these layers, a carding process may be performed during the manufacture of each to align the fibers of the nonwoven material in a desired direction. Subsequent to carding, the nonwoven layers 2, 4 may be compressed together and then passed through a needling machine to lock the aligned fibers together and to compress the layers into a tighter, thinner, more dense, configuration. Thus formed, the nonwoven layers achieve a level of strength in the direction of fiber alignment that they did not possess prior to carding or needling.

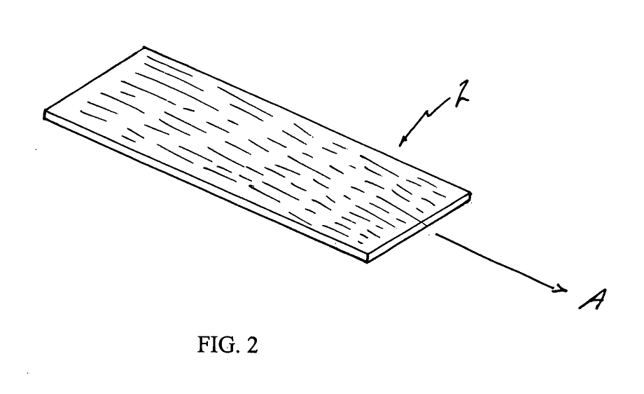

Referring to FIG. 2, the first nonwoven layer 2 may comprise a felt material composed of staple fibers that have been carded to align the fibers in the longitudinal direction signified by arrow “A” (i.e., the fibers are substantially parallel to the running direction of the ultimate conveyor belt 1). As shown in FIG. 2, the first nonwoven layer 2 comprises a roll of carded nonwoven material suitable for use in a continuous conveyor belt forming process. The resulting layer 2 will have greater strength in the longitudinal direction than the lateral direction, due to the fiber alignment afforded by the carding process. It will be appreciated that the first nonwoven layer 2 can be formed into batts of discrete lengths, or it may be formed into a continuous layer of material that may be rolled for storage awaiting further processing. Additionally, as part of a continuous manufacturing operation the first nonwoven layer 2 may be formed continuously and fed directly to a needling stage for direct incorporation into the carcass 12.

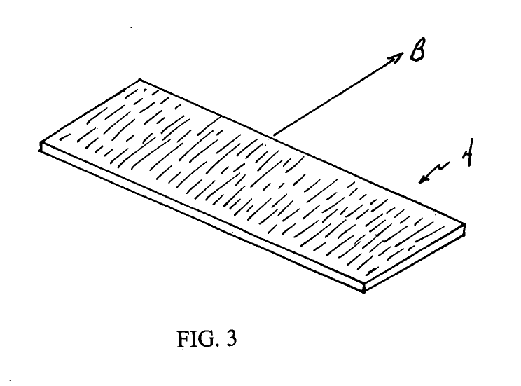

Referring to FIG. 3, the second nonwoven layer 4 may comprise a felt nonwoven material composed of staple fibers similar to that of FIG. 2, except that the fibers have been carded so that they align in the transverse direction of the material signified by arrow “B” (i.e., substantially perpendicular to the running direction of the conveyor belt 1 of which the layer 4 will ultimately be a part). As with the first layer 2, the second nonwoven layer 4 may be formed in segments of discrete length, or it may be formed as a continuous layer that may be rolled for storage awaiting further processing. The resulting layer 4 will have greater strength in the lateral direction than in the longitudinal direction, again, due to the fiber alignment provided by the carding process.

To ensure dimensional stability and structural integrity of the carded first and second nonwoven layers 2, 4 during handling, the layers 2, 4 may be subjected to a needling process immediately after being carding and pressed. Although this is not critical, it may serve to prevent damage to the layers 2, 4 if they are inadvertently subjected to forces perpendicular to the direction of fiber alignment prior to the layers being joined together: This may be less important for the longitudinally carded layer 2, and more important for the laterally carded layer 4. This is because the longitudinally carded layer 2 will have some strength in the longitudinal direction which will protect it from handling damage or damage due to forces applied during further processing steps. For the laterally carded layer 4, however, its tensile strength will be low, and post-carding needling will serve to advantageously increase the tensile strength of the layer 4 so that it will not be degraded (e.g., pulled apart) during handling or when tensile forces from the processing apparatus are applied in subsequent processing steps.

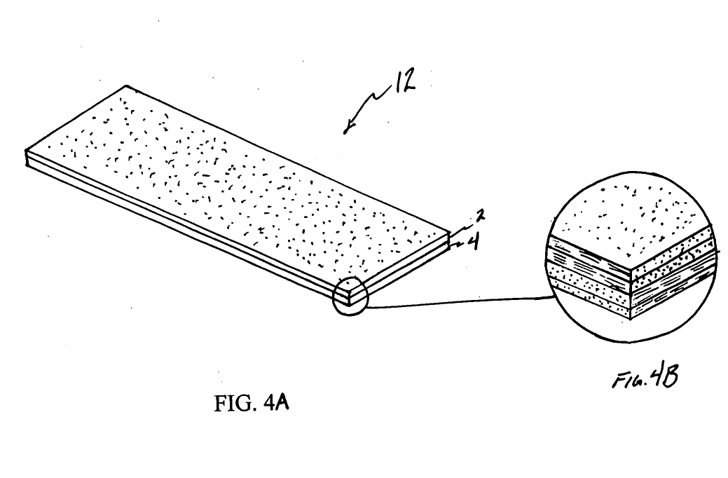

After carding, and optionally needling, the first and second nonwoven layers 2, 4 may be layered as desired, and then needled together. The needling step will serve to fix and compress the layers together to form a multilayer carcass 12 (see FIG. 4). The resulting carcass 12 will have desired strength in both the longitudinal and lateral directions owing to the cross laying of the layers 2, 4. Once the carcass 12 has been formed, it can either be rolled up and stored for later fabrication into a finished conveyor belt 1, or it can be immediately directed from the needling stage to elastomer application and finishing stages. It is noted that in some applications, the carcass 12 may be used as a finished conveyor belt without any elastomer being applied.

Advantageously, the strength of the belt 1 in the longitudinal and lateral directions may be adjusted by adjusting the characteristics of each of the first and second nonwoven layers 2, 4. In one exemplary embodiment in which the first and second nonwoven layers are made from the same nonwoven base material, the belt strength in the lateral and longitudinal directions can be adjusted simply by adjusting the relative basis weights of the material used to form the first and second nonwoven layers 2, 4. For example, to provide a finished belt 1 having a strength ration of 35:65 (lateral to longitudinal), the first nonwoven layer 2 may have a basis weight of 65% of the total carcass weight (where carcass weight is taken the combined weight of the first and second nonwoven layers 2, 4) and the second nonwoven layer 4 may have a basis weight of 35% of the total carcass weight. This exemplary 35/65 longitudinal/lateral strength ratio is a typical strength balance for a conveyor belt, but it will be appreciated that other strength ratios can be achieved simply by adjusting the relative basis weights of the first and second nonwoven layers 2, 4.

Other characteristics of the individual nonwoven layers 2, 4 can also be adjusted to obtain a finished belt having desired longitudinal and lateral strengths. Thus, fiber material types, fiber dimensions, needling density, needle size, type, orientation and depth of needle penetration, all can be selected for each nonwoven layer 2, 4 to provide desired finished strength ratios for a finished conveyor belt 1.

The inventors have found, however, that by specifying a particular material type and density of the finished layers 2, 4 that a belt carcass 12 having a desired strength, as well as a desired strength ratio (lateral:longitudinal), can be obtained irrespective of the type of needling apparatus used. Thus, although a wide variety of needling machines, needle types, etc. are available, it is possible to achieve the desired final belt characteristics simply by specifying a density and thickness for each layer 2, 4, rather than by specifying a particular needling setup be used. The benefits of this are clear, because it provides the user the option of obtaining the first and second layers 2, 4 in bulk form from a nonwoven material manufacturer, each of whom may have their own unique needling machines and needle configurations.

Although FIGS. 1-4A show a carcass 12 formed from first and second nonwoven layers 2, 4, the carcass 12 alternatively may be formed from more than two nonwoven layers. Thus, each of the first and second layers 2, 4 can be made up of multiple sub-layers, each of which may be needled or otherwise fixed together. These sublayers may be combined in any manner (e.g., different fiber orientations, degree of needling, basis weight, different staple fiber deniers, different staple fiber lengths, different material types) to provide a carcass 12 having desired strengths and stiffnesses in the lateral and longitudinal directions.

In one exemplary alternative embodiment, shown in FIG. 4B, the first and second nonwoven layers 2, 4 each comprise first and second individually carded sublayers 2a, 2b, 4a, 4b. The carding direction of the sublayers may match the carding direction of the layer (2 or 4) of which the sublayer will be a part. The sublayers 2a, 2b; 4a, 4b may then be needled together to form the first and second nonwoven layers 2, 4, which are subsequently needled together to form the carcass 12. Alternatively, the sublayers may all be combined together in one needling step, if desired.

It is further contemplated that the first individual sublayer 2a, 4a may be carded such that its fibers are aligned in a direction different from that of the second individual sublayer 2b, 4b. Thus, the first sublayers 2a, 4a may have their fibers aligned in the longitudinal direction, while the second sublayers 2b, 4b may have their fibers aligned in the lateral direction. Such an arrangement would result in each of the nonwoven layers 2, 4 having a desired longitudinal:lateral strength ratio. The individual layers 2, 4 then could be used to form a variety of nonwoven belts 1 having different desired strengths. Thus, a light service belt could be formed from two nonwoven layers 2, 4 while a heavier service belt could be formed from three or more nonwoven layers. This would enable the pre-manufacture and storage of a large number of rolls of the nonwoven layers 2, 4 which could later be easily combined to form a belt having a desired final strength.

Where the layers 2, 4 and/or sublayers 2a, 2b, 4a, 4b will be manufactured and then stored prior to being integrated into a carcass 12, the layers or sublayers may each be needled to minimize the chance of handling damage.

After the first and second nonwoven layers 2, 4 (including any sublayers as applicable) are layered and needled together, the elastomer component 6 may be applied to form the finished belt 1. Any of a variety of techniques may be used to apply the elastomer component, including dipping or calendaring, or combinations thereof. Typically, a dipping process in which the carcass 12 is submerged in a liquid elastomer will be sufficient to achieve a desired level of impregnation of the carcass with the elastomer. As previously noted, the elastomer (and its application process) can be important factors in achieving a desired belt strength and integrity because the elastomer serves to lock the carcass layers together when it is cured, thus preventing the layers 2, 4 from delaminating over the lifetime of the belt 1. In some instances, it may be desirable to apply a vacuum or other appropriate technique to facilitate impregnation of the carcass with the elastomer. Alternatively, dipping coupled with agitation such as by passing the belt through a squeegee/roller system. As noted, calendaring may also be used, in combination with dipping/agitation to ensure the elastomer component 6 penetrates the fibers of the first and second non-woven layers 2, 4.

Other elastomer applications may also be employed as desired and depending on the type of elastomer compound used. In one non-limiting example, a hot extrusion coating process may be employed to form top and/or bottom covers 8, 10 to one or more surfaces of the carcass 12. Additionally, combinations of application processes may be used, such as where the carcass is dipped into a first elastomer and cured, and then top and bottom covers 8, 10 are extrusion coated onto the carcass using a second elastomer.

The elastomer application process may also be adjusted to customize the degree of penetration of the elastomer into the first and second nonwoven layers 2, 4, and also to control the thickness of the top and bottom covering layers 8 and/or 10 if such layer(s) are desired. This may be important because the type of elastomer and the degree of penetration of the elastomer into the carcass are expected to affect the ultimate strength of the finished belt. Thus, while the densities and thicknesses of the first and second nonwoven layers may be adjusted to adjust the ratio of belt strength in the longitudinal and lateral directions, the degree of impregnation as well as the type of elastomer may likewise be adjusted to obtain the ultimate strength and integrity of the finished belt 1.

The aforementioned elastomer applications can be used to obtain a finished conveyor belt 1 having a desired surface configuration. Where the carcass 12 is simply impregnated with an elastomer component 6, a portion of the surfaces of each of the nonwoven layers 2, 4 may remain exposed. In such cases, the nonwoven layers 2, 4 may be “singed” to melt the outer surface of the nonwoven material layers, locking them together and preventing the surface from “fuzzing” on the surface, thus enhancing the smoothness of the surface finish, thus reducing rolling friction and attendant noise Additionally, the exposed nonwoven surfaces may be ground to enhance their smoothness.

It is also contemplated that the carcass 12 will be dipped in the elastomer component 6 so that the elastomer will penetrate only half of the carcass 12, resulting in one side being saturated with elastomer and the other side being bare.

It will be appreciated that in some belt applications it may be also desirable to leave the carcass entirely bare, eliminating the elastomer component 6 entirely. Such an arrangement, while providing a very low coefficient of dynamic friction, would also have lower durability due to the lack of elastomer 6.

Other arrangements include a belt 1 having a cover layer 8 on only one side, with the other side merely being impregnated with elastomer 6. In such a case, the cover 8 may be applied to provide an enhanced coefficient of friction for engagement with the conveyed material. Such an arrangement may be employed where conveyed material is being carried up an incline.

Further, the cover(s) 8, 10 and/or the impregnated carcass 12 may have a physical profile embossed or otherwise formed into its surface to give it increased “grip” on the conveyed material.

Any of a variety of natural or synthetic elastomeric materials suitable for conveyor belt applications may be used as the elastomeric material 6. A non-limiting list of exemplary materials includes chloro-sulfonyl-polyetheylene (e.g., product sold under the trade name Hypalon®), polyethylene terephthalase (e.g., product sold under the trade name Hytrel®), natural rubber, chloroprene, nitrile-butadiene rubber, butadiene rubber, isoprene, styrene-butadiene, modified polysiloxanes, polyester urethane, polyether urethane, polyvinyl chloride, fluorocarbon polymers, ethylene propylene rubber (EPR), and the like. In a preferred embodiment, the elastomeric material comprises PVC plastisol.

The elastomeric material may also comprise additives for enhancing flame retardancy, wear and chunk resistance, rolling resistance, aging resistance (e.g., ozone and UV resistance), and the like. Vulcanization aids, cross-linking agents, oils, accelerators, or other formation aids may also be used as appropriate.

Similarly, the first and second nonwoven layers 2, 4 may be formed from any of a variety of materials, including a wide variety of synthetic and manmade fibers, such as polyester, nylon, aramid (e.g., Kevlar), glass, polypropylene, cellulose, wool, or others.

Additionally, a variety of individual fiber sizes may be selected for the first and second nonwoven layers 2, 4. The individual fibers may be from about 1 denier to about 6 denier, and may be from about 1-inch to about 6-inches in length, with 3 inches length and 3-4 denier being preferable. The denier and length of the fibers used to form the nonwoven layers 2, 4 may each be selected to yield desired strength properties for the final conveyor belt 1. For example, a 2 denier fiber could be provided in a 3 inch length, or a 4 denier fiber could be provided in a 3 inch length. Additionally, the denier of the fiber may be selected to provide a desired final surface texture for the carcass and/or the finished belt (i.e., a finer denier generally resulting in a softer final surface of the carcass).

In one embodiment, the first and second nonwoven layers 2, 4 are made from staple polyester nonwoven felt material comprising 3 denier, 3-inch long staple fibers.

As previously noted, the finished belt 1 may have any of a variety of surface configurations, including top and bottom covers 8, 10 of solid elastomer, top cover 8 only and bare bottom, bare top and bottom, and the like. Further, the top and bottom covers 8, 10, where used, may be formed of the same elastomer compound as used to impregnate the carcass 12, or they may be made from a different elastomer compound. Additionally, the top and bottom covers 8, 10 may themselves be made from different compounds and/or may have different surface finished applied. This may be advantageous where it is desirable to provide a smooth surface finish to the bottom surface (that which will be in contact with the conveyor pulleys and rollers) while providing a rougher finish on the top in order to provide good retention/holding of the materials being carried by the conveyor. It may also be desirable where some heat resistance is needed for the top cover, but is unnecessary for the bottom cover. In one embodiment, for package handling or luggage handling operations, the belt 1 may have a bare surface (i.e., an exposed carcass surface) on the bottom side for interaction with the pulleys and rollers of the conveyor system). Again, where a bare carcass surface is desired, the surface may be subjected to a grinding operation to remove protruding fibers and provide an even smoother surface finish; or the first and second nonwoven layers 2, 4 may also be singed prior to application of the elastomeric material 6.

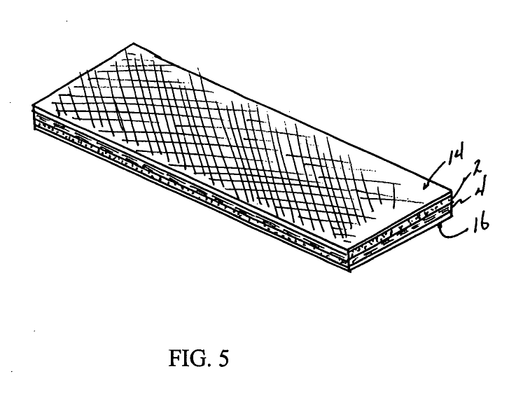

Referring now to FIG. 5, one or more continuous reinforcement layers 14, 16 may be needled onto one side or both of the first and second nonwoven layers 2, 4. These continuous reinforcement layers 14, 16 may provide substantial additional strength to the conveyor belt 1, and may also serve to protect the first and second nonwoven layers 2, 4 from damage due to impact from objects being dropped onto the belt 1. In one embodiment, the first and second continuous reinforcement layers 14, 16 comprise a light weight breaker fabric of from about 5 to about 14 ounces per yard, such as a single layer leno weave fabric. It is also contemplated that a reinforcement layer could be sandwiched between the first and second nonwoven layers 2, 4.

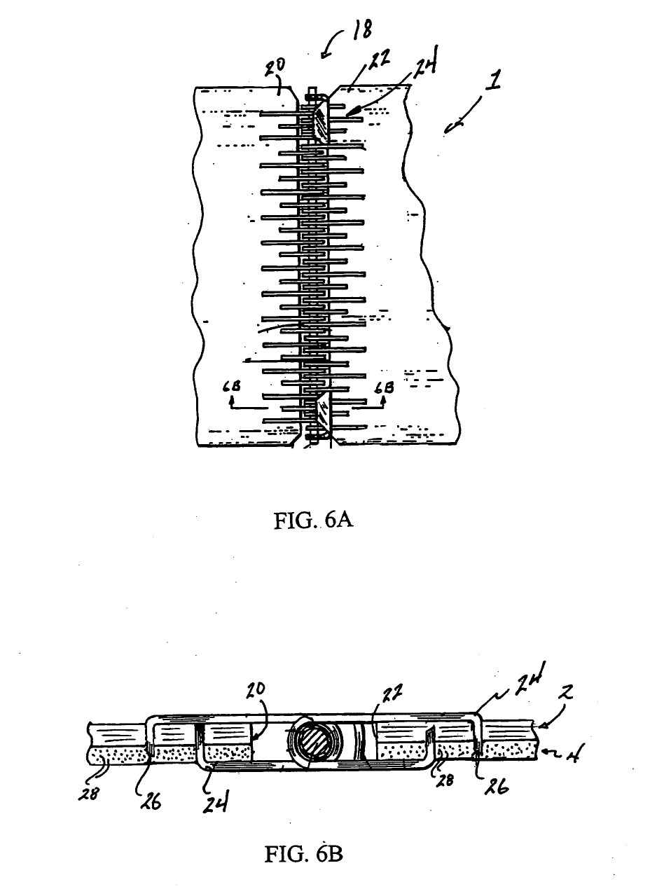

Referring to FIGS. 6A and 6B an exemplary fastener arrangement is illustrated for use with the conveyor belt 1. Specifically, FIG. 6A shows a typical splice joint 18 used to join opposing ends 20, 22 of a conveyor belt 1 together. Thus, the splice joint 18 comprises a series of laces 24 that penetrate the belt carcass 12 to hold the opposing ends 20, 22 of the belt 1 in close relation. As will be appreciated, the pullout force of the fastener laces 24 during operation will tend to cause the carcass 12 to break or cause the carcass fibers to pull apart, which may cause belt failure. As shown in FIG. 6B, the laterally oriented fibers 28 of the second nonwoven layer 4 may provide substantial resistance to pullout of the fastener laces 24, thus providing a high integrity splice joint 18 that exceeds the strength of traditional nonwoven carcass designs that do not employ a laterally-carded component.

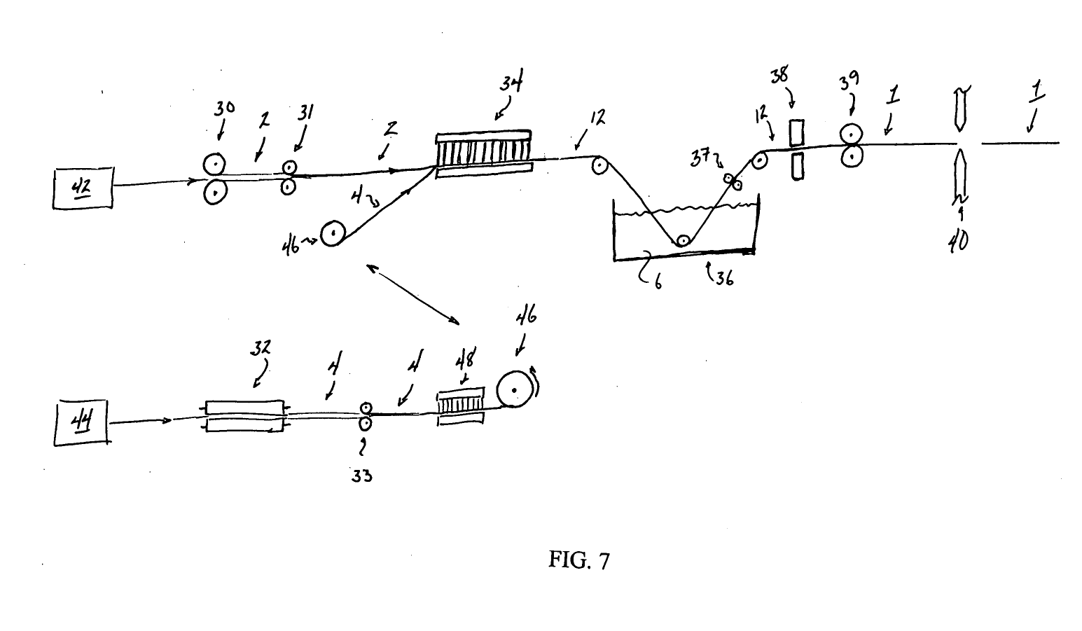

A substantial advantage of the disclosed belt design is that it is amenable to manufacture using a continuous process, which can reduce the cots of production in terms of time and manpower. Broadly described in relation to FIG. 7, first and second nonwoven layers 2, 4 may be formed by carding and pressing bulk staple fiber material to form batts having a desired fiber orientation, and then feeding them together into a needling stage 34. The resulting needled carcass 12 may then be submerged in a bath 36 containing elastomer compound 6 and directed to a calendaring stage 38, in which the elastomer is further pressed into the fibers of the carcass 12 and the top and bottom cover layers 8, 10, if desired, are formed. The finished belt 1 may be cut to length by cutting section 40.

Describing the process in greater detail, the first and second nonwoven layers 2, 4 may be formed from what initially consist of bales of bulk staple fibers 42, 44. The bales are fluffed and combed, then fed through an air chamber to separate the individual fibers. The fibers are then carded in separate carding steps 30, 32.

For the first nonwoven layer 2 carding 30 is performed to align the fibers of the first nonwoven layer 2 along the longitudinal direction of the layer 2 (arrow A of FIG. 2). The first nonwoven layer 2, in its carded form, may then be subjected to one or more squeeze roller stages 31 that squeeze/compress the carded material and to tack the layer 2 together. The compressed layer 2 may then be cut to length, rolled up into a roll form for storage, or it may be fed directly to the next stage in the manufacturing process, which in the illustrated embodiment is the needling stage 34. For the second nonwoven layer 4, carding 32 is performed to align the fibers of the second nonwoven layer 4 along the lateral direction of the layer 4 (arrow B of FIG. 3). The layer is then subjected to one or more squeeze roller stages 33 to tack the layer together, and then rolled up in roll form 46 for storage or fed directly to the next stage in the manufacturing process.

As previously noted, since the second nonwoven layer 4 has been carded to align the fibers in the lateral direction, the layer may have little strength in the longitudinal direction of the roll, and thus it may be easily damaged when subjected to longitudinally-applied forces. Thus, the second nonwoven layer 4 may be subjected to an intermediate needling stage 48 immediately subsequent to carding and pressing. This intermediate needling may provide needed dimensional and structural stability to the second nonwoven layer 4 and will minimize the chance for damage to the layer 4 caused by longitudinal forces (e.g., machine forces applied to the layer by the manufacturing process equipment).

Once the first and second nonwoven layers 2, 4 have been carded and pressed (and the second nonwoven layer 4 has been needled), the two layers may thereafter be directed to a needling stage 34 in which the layers may be compressed, fixed together, and strengthened. In one embodiment, the nonwoven layers 2, 4 may be subjected to more than one needling step as appropriate to enhance the strength and stiffness of the resulting carcass 12.

Upon exiting the needling stage 34, the carcass 12 may be fed into an impregnation bath 36 containing an elastomer compound 6, which in one embodiment comprises a liquid plastisol PVC material. The impregnated carcass 12 may then be squeezed or scraped 37 to remove excess elastomer, and then directed to a curing stage 38 in which the elastomer is subject to heat or other stimulus to cure the elastomer compound 6. The cured carcass 12 may then be fed through one or more finishing rolls 39 to impart a desired surface finish to the resulting belt 1. Where covers 8, 10 are applied to the carcass 12, such application may occur subsequent to the curing stage 38 but prior to the finishing rolls 39. The belt may then be cut to length at cutting stage 40

The finishing rolls, or other embossing or reforming rolls, may be also be used to apply different surface finishes to the top and bottom surfaces of the belt 1. In one exemplary embodiment, a thicker layer of elastomer could be applied to one side of the carcass 12, and an embossed finishing roll could be used to apply a desired surface finish or configuration to that side. Embossing could also be performed directly on the exposed nonwoven surface by applying sufficient heat (e.g., from a radiant heat source) to the surface of the carcass 12 to soften the staple fibers (and the elastomer 6) and then immediately passing the carcass through the embossed finishing roller. Once cooled, the carcass surface will retain the embossed shape.

Further, one or more elastomer covers 8, 10 could be applied either via dipping or extrusion coating and then cured. The resulting material may then be rolled up in a roll and carried to a separate process area where embossing rolls (often referred to as “reforming” rolls) having a desired pattern (e.g., chevron, rough textured pattern or the like) may be used to impart the desired surface finish.

In lieu of the elastomer bath 36, the carcass 12 may be fed directly to a calendaring stage in which a heated elastomer compound 6 is applied and pressed into the carcass 12 under heat and pressure by the calendar rollers. Thereafter, the impregnated carcass may be subjected to additional processing steps as desired to impart top and bottom covers 8, 10 and the desired surface finishes to the completed belt 1.

It will be appreciated that if the first and second nonwoven layers 2, 4 are each made from discrete sublayers, that additional intermediate carding and needling steps may be employed between the stages described above in relation to FIG. 7.

Further, if the belt 1 is to have one or more continuous reinforcement layers 14, 16, these layers may be applied at any of a number of stages in the manufacturing process. For example, a single reinforcing layer could be needled to each of the first and second nonwoven layers 2, 4, after the nonwoven layers 2, 4 have been carded. The nonwoven layers 2, 4 (with associated reinforcing layers) could then be needled together to form a reinforced carcass 12. This may be of advantage for use with the second nonwoven layer 2, which as previously noted may have little strength in the longitudinal direction. Needling a continuous reinforcement layer 16 to the laterally-carded second nonwoven layer 4 may provide a desired additional degree of strength to the layer 4, in addition to the modicum of strength provided by the needling operation itself.

Although the manufacturing process has been described as a series of immediately successive process steps, such continuous progression is not critical. Thus, for example, it may be feasible and desirable to card the first and second nonwoven layers 2, 4 and then store them in roll form (or ship them to another location) awaiting subsequent processing steps. Likewise, it may be desirable to needle the first and second nonwoven layers 2, 4 together and then to roll up the carcass 12 in a roll to await further processing.

### EXAMPLE

A conveyor belt was constructed from two layers of 30 ounce per square yard (opsy) 100% nonwoven material. The first layer was staple carded length wise, and the second layer was staple carded widthwise. The first layer comprised 65% of the total weight of the two layers, while the second layer comprised the remainder. The first and second layers were needled together and the top and bottom surfaces of the resulting carcass were singed. The singed carcass was then dipped into a bath of PVC and directed through squeegee rolls to remove excess PVC material from the carcass surfaces. The impregnated carcass was then passed to a curing oven to cure the PVC. Upon exiting the curing oven, the product was sent through a series of finishing rolls to provide a smooth final surface to the finished belt. The final construction comprised a 1 mil thickness of PVC as the top cover, a carcass play of 133 mils, a 1 mil thickness of PVC as the bottom cover. Total belt thickness was 135 mils.

### Test Results

Tensile testing of the belt thus constructed was performed using an Instron tensile testing machine, with standard ASTM tensile test samples prepared according to ASTM D378. The “Force at Tear” and “Flame” tests were also performed in accordance with ASTM D378. The “Coefficient of Sliding Friction” test was performed in accordance with ASTM D1894. Rigidity testing was also performed to determine stiffness of the resulting samples. Testing was performed on belt samples measuring 1-inch wide and 10-inches long. Results indicate the load required to stretch the sample 1″ in length.

| Test | Results | Average |
|---|---|---|
| Tensile Longitudinal, | 682, 726, 729, | 712 |
| pounds-force per inch width | | |
| of belt (PIW) | | |
| Elongation at 120 Lbs; % | 1.5, 1.0, 1.0 | 1.2 |
| Elongation at Break, % | 17.0, 16.5, | 16.7 |
| | 16.5 | |
| Tensile Transverse, pounds- | | 300 |
| force per inch length of belt | | |
| (PIL) | | |
| Elongation at Break, % | | 68 |
| Rigidity Longitudinal; lb/in | | 0.30 |
| Rigidity Transverse; lb/in | | 0.05 |
| Force at Tear; lb | | 4″ width = 41 |
| | | 12″ width = 50 |
| Coefficient of Sliding | | .32 Top Surface |
| Friction | | .15 Bottom Surface |
| Flame | | 2 sec. flame out and 4 sec. |
| | | afterglow |
| | | 3 sec. flame out and 7 sec. |
| | | afterglow |

Dynamic flex fatigue testing, designed to simulate the dynamic loading conditions experienced by a conveyor belt during operation, was also performed to test belt fatigue and mechanical fastener holding capability of the example test belt sample. Testing was performed using reduced size (4-inch width) pilot conveyor test belt connected using galvanized Clippers #2HT fasteners. The belt was run around 12-inch drive and driven pulleys and through a 3½-inch diameter reverse flex hitch puller arrangement. Belt tension was about 100 pounds per inch width, and running speed was 600 feet per minute. The belt was then run for approximately 312,000 cycles. No belt or fastener related failures were encountered during the test. Some surface cracks were observed in the belt at the location of fastener penetration after about 211,000 cycles, but they did not propagate.

| Test | Results |
|---|---|
| Tensile, pounds-force per | 566 (before flex testing) |
| inch width of belt (PIW) | 484 (after flex testing) |
| Elongation at Break, % | 21.7 (before flex testing) |
| | 19.0 (after flex testing) |
| Max Elongation during flex | 1% |
| testing | |

It will be understood that the description and drawings presented herein represent an embodiment of the invention, and are therefore merely representative of the subject matter that is broadly contemplated by the invention. It will be further understood that the scope of the present invention encompasses other embodiments that may become obvious to those skilled in the art, and that the scope of the invention is accordingly limited by nothing other than the appended claims.

1. A low-noise conveyor belt, comprising:
a first nonwoven layer having a first fiber orientation;
a second nonwoven layer having a second fiber orientation, the second nonwoven layer disposed over the first nonwoven layer; and
an elastomer contacting at least one of the first and second nonwoven layers;
wherein the first and second fiber orientations are non-parallel.

2. The low-noise conveyor belt of claim 1, wherein at least one of the first and second nonwoven layers comprises needled felt.

3. The low-noise conveyor belt of claim 1, wherein the first and second nonwoven layers are fixed together by needling.

4. The low-noise conveyor belt of claim 1, wherein the first nonwoven layer has a first weight and the second nonwoven layer has a second weight, the first and second weights being unequal.

5. The low-noise conveyor belt of claim 4, wherein the first and second nonwoven layers comprise a total nonwoven weight, the first nonwoven layer comprising about 65% of the total nonwoven weight and the second nonwoven layer comprising about 35% of the total nonwoven weight.

6. The low-noise conveyor belt of claim 5, wherein the first fiber orientation is substantially parallel to a longitudinal axis of the conveyor belt, and the second fiber orientation is substantially perpendicular to the longitudinal axis of the conveyor belt.

7. The low-noise conveyor belt of claim 1, wherein the first and second nonwoven layers are impregnated with the elastomer.

8. The low-noise conveyor belt of claim 7, wherein the elastomer comprises polyvinylchloride (PVC).

9. The low-noise conveyor belt of claim 1, wherein the first nonwoven layer comprises two or more individual plies of nonwoven material.

10. The low-noise conveyor belt of claim 9, wherein the second nonwoven layer comprises two or more individual plies of nonwoven material.

11. A conveyor belt structure comprising:
a first layer of nonwoven material comprising staple fibers oriented in a first direction; and
a second layer of nonwoven material comprising staple fibers oriented in a second direction, said second layer of nonwoven material disposed over said first layer of nonwoven material;
wherein the first and second layers of nonwoven material are oriented with respect to each other such that the first direction is substantially parallel to a longitudinal axis of the conveyor belt and the second direction is non-parallel to the longitudinal axis.

12. The conveyor belt structure of claim 11, further comprising an elastomer material contacting at least one of the first and second layers of nonwoven material.

13. The conveyor belt structure of claim 11, wherein the first and second layers of nonwoven material are fixed to each other by needling such that some of the staple fibers of the first layer are interlaced with some of the staple fibers of the second layer.

14. The conveyor belt structure of claim 11, wherein the first layer of nonwoven material has a first weight and the second layer of nonwoven material has a second weight, the first and second weights being unequal.

15. The conveyor belt structure of claim 11, wherein the second direction is substantially perpendicular to the longitudinal axis of the conveyor belt.

16. The conveyor belt structure of claim 15, wherein the first and second layers of nonwoven material comprise a total nonwoven weight, the first layer of nonwoven material being about 65% of the total nonwoven weight and the second layer of nonwoven material being about 35% of the total nonwoven weight.

17. The conveyor belt structure of claim 11, wherein the first and second layers of nonwoven material are impregnated with an elastomer.

18. The conveyor belt structure of claim 17, wherein the elastomer comprises polyvinylchloride (PVC).

19. The conveyor belt structure of claim 11, wherein the first layer of nonwoven material comprises two or more individual plies of nonwoven material.

20. The conveyor belt structure of claim 19, wherein the second layer of nonwoven material comprises two or more individual plies of nonwoven material.

21. A method of making a conveyor belt structure, comprising:
providing a first nonwoven layer having a first staple fiber orientation;
providing a second nonwoven layer have a second staple fiber orientation; and
disposing the first nonwoven layer on the second nonwoven layer and needling the layers together to form a conveyor belt carcass.

22. The method of claim 21, wherein the step of providing a first nonwoven layer comprises carding a first nonwoven material to align a substantial portion of the fibers in the first material in the first staple fiber orientation; and the step of providing a second nonwoven layer comprises carding a second nonwoven material to align a substantial portion of the fibers in the second material in the second staple fiber orientation.

23. The method of claim 22, wherein the first nonwoven layer comprises a first length of material, the first staple fiber orientation being aligned with a longitudinal axis of said first length of material, and wherein the second nonwoven layer comprises a second length of material, the second stable fiber orientation being substantially perpendicular to a longitudinal axis of said second length of material.

24. The method of claim 21, further comprising needling the second nonwoven layer prior to disposing the first nonwoven layer on the second nonwoven layer.

25. The method of claim 21, wherein the first and second nonwoven layers are provided in roll form, and the step of disposing the first nonwoven layer on the second nonwoven layer and needling the layers together is performed by rolling out the first and second nonwoven layers and continuously feeding them into a needling apparatus.

26. The method of claim 21, further comprising impregnating at least a portion of the carcass with an elastomeric compound.

27. The method of claim 26, wherein the impregnating step comprises dipping at least a portion of the carcass in a bath of liquid elastomer.

28. The method of claim 26, wherein the elastomer comprises PVC plastisol.

29. The method of claim 21, further comprising singeing at least one side of the carcass.

30. The method of claim 21, further comprising applying a cover material to at least one side of the carcass.

31. The method of claim 21, wherein the step of providing a first nonwoven layer comprises selecting a first nonwoven material having a first basis weight, and the step of providing a second nonwoven layer comprises selecting a second nonwoven material having a second basis weight, the first and second basis weights selected to achieve a desired ratio of strength between the length and the width of the unitary structure.

32. The method of claim 31, wherein the first basis weight is about 65% of a total weight of said unitary structure and the second basis weight is about 35% of the total weight.

33. A continuous process for making a multi-ply nonwoven conveyor belt structure, comprising
providing a first nonwoven material having a first staple fiber orientation;
providing a second nonwoven material have a second staple fiber orientation;
dispensing the first and second nonwoven materials in a machine direction;
disposing the first nonwoven material on the second nonwoven material and needling the materials together to form a unitary structure; and
contacting at least a portion of the unitary structure with an elastomer compound.

34. The method of claim 33, wherein the step of providing a first nonwoven material comprises carding the first nonwoven material to align a substantial portion of the fibers in the first material in the first staple fiber orientation, then rolling up said first material to form a first roll.

35. The method of claim 33, wherein the step of providing a second nonwoven material comprises carding a second nonwoven material to align a substantial portion of the fibers in the second material in the second staple fiber orientation, needling the nonwoven material to provide structural stability, and then rolling up said second material to form a second roll.

36. The method of claim 35, wherein the first staple fiber orientation is substantially parallel to a longitudinal axis of said first nonwoven material, and the second staple fiber orientation is substantially perpendicular to a longitudinal axis of said second nonwoven material.

37. The method of claim 33, wherein the step of disposing the first nonwoven material on the second nonwoven material and needling the materials together to form a unitary structure is performed by continuously feeding the first and second nonwoven materials into a needling apparatus.

38. The method of claim 33, wherein the contacting step comprises submerging the unitary structure in a bath of liquid elastomer.

39. The method of claim 33, wherein the contacting step comprises an extrusion coating process.

40. The method of claim 33, wherein the elastomer compound comprises PVC plastisol.

41. The method of claim 33, further comprising singeing at least one side of the unitary structure.

42. The method of claim 33, further comprising applying a cover material to at least one side of the unitary structure.

43. The method of claim 33, wherein the step of providing a first nonwoven material comprises selecting a first nonwoven material having a first basis weight, and the step of providing a second nonwoven material comprises selecting a second nonwoven material having a second basis weight, the first and second basis weights being selected to achieve a desired ratio of strength between the length and the width of the unitary structure.

44. The method of claim 43, wherein the first basis weight is about 65% of a total weight of said unitary structure and the second basis weight is about 35% of the total weight.
